(19) United States
(12) Patent Application Publication
(10) Pub. No.: US 2007/0283131 A1
(43) Pub. Date: Dec. 6, 2007

(54) Processing of high priority data elements in systems comprising a host processor and a co-processor

(75) Inventors: Serguei Sagalovitch, Richmond Hill (CA); Hing Pong Chan, Toronto (CA); Alexei Yurin, Gormley (CA)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 11/342,906

(22) Filed: Jan. 30, 2006

(51) Int. Cl. G06F 9/40

(52) U.S. Cl. 712/203; 712/E09.082

(57) ABSTRACT

To provide for the processing of priority data elements between a host processor and a co-processor that exchange such data elements using a queue, the host processor determines a priority of a data element received from an application. If the priority is higher than a lowest possible priority value, at least one lower priority data element within the queue may be identified and modified thereby temporarily removing it from the queue. When the priority data element is written into the queue a query packet is included that will cause the co-processor to return information regarding a last executed queued data element. Based on the returned information, the host processor can determine one or more unmodified data elements (uniquely corresponding to the one or more modified queued data elements) to be written into the queue in accordance with a sequence of the previously modified queued data elements.

### FIELD OF THE INVENTION

The invention relates generally to systems comprising a host processor and a co-processor and, in particular, to techniques for high priority data elements in such systems.

### BACKGROUND OF THE INVENTION

In computers and other devices it is known for a host processor to execute one or more applications (for example, graphics applications, word processing applications, drafting applications, presentation applications, spreadsheet applications, video game applications, etc.) that may require specialized or intensive processing. In those instances, the host processor will sometimes call upon a co-processor to execute the specialized or processing-intensive function. For example, if the host processor requires a drawing operation to be performed, it can instruct, via a data element (such as a command, instruction, pointer to another command, group of commands or instructions, address, and any data associated with the command), a video graphics co-processor to perform the drawing function.

Processing systems that include at least one host processor, memory, and at least one co-processor are known to use a queue (sometimes referred to as a ring buffer) stored in the memory to facilitate the exchange of data elements between the host processor and the co-processor. The host processor generates multiple data elements (e.g. commands) that relate to a particular application and writes the data elements into the queue, which can be organized to operate in a ring or circular fashion, i.e., when the end of the queue is reached, processing (reading data from or writing data to the queue) continues at the beginning of the queue. As the host processor enters the data elements into the queue, it updates a write pointer sequentially which indicates the next location within the queue available to a have a data element written thereto. The co-processor in turn sequentially reads the data elements from the queue and updates a read pointer which indicates the location of the next data element to be read from the queue. The co-processor and host processor exchange the updated write and read pointers as they are updated such that both the co-processor and host processor have current records of the read and write pointer locations. In this manner, the host processor can continuously provide data elements to the queue for consumption by the co-processor.

It is known that certain applications have relatively strict operating requirements relative to other applications. For example, a video playback application typically must operate in real time (i.e., without any substantial delays in rendering the stream of images) in order to provide a satisfactory user experience. On the other hand, other applications with less stringent operating requirements may be able to better tolerate delays in processing. In these instances, it would be beneficial to allow applications have relatively strict operating requirements to have priority access to co-processor functionality relative to other, more delay-tolerant applications. In terms of the queuing interface between a host processor and a co-processor, this translates into establishing a system for processing high priority data elements ahead of previously queued, lower priority data elements. However, in many current systems, such functionality either does not exist or suffers from a number of drawbacks.

For example, specialized hardware may be incorporated into the host processor and co-processor to provide priority functionality. However, this does not address existing processor/co-processor combinations that do not employ such specialized hardware. Another technique requires each application to use the co-processor in a manner that is cooperative with the other applications. However, such techniques often fail to perform well if one application tends to dominate the others. Yet another technique calls for resetting the co-processor and re-arranging the queue according to priority. Obviously, if either of the resetting or rearranging processes takes too long, unacceptable delays may still be incurred. Further still, the host processor could maintain separate queues according to priority and submit data elements from these queues one at a time. However, this would require the host processor to check the co-processor's status to ensure that the previous data element had been fully processed. This process of continually checking co-processor status can lead to further delays

Accordingly, it would be advantageous to provide a technique for processing high priority data elements in processor/co-processor systems that does not suffer from the drawbacks described above.

### BRIEF DESCRIPTION OF THE DRAWINGS

The invention will be more readily understood in view of the following description when accompanied by the below figures and wherein like reference numerals represent like elements:

FIG. 1 is a schematic block diagram of a processing system in accordance with an embodiment of the present invention;

FIG. 2 is a flowchart illustrating processing of a priority data element in accordance with an embodiment of the present invention;

FIG. 3 is a schematic illustration of a data element in accordance with an embodiment of the present invention;

FIG. 4 is a schematic illustration of a data element header in accordance with an embodiment of the present invention;

FIG. 5 is a flowchart illustrating in greater detail the determination and modification of lower priority queued data elements in accordance with an embodiment of the present invention; and

FIGS. 6-10 are schematic illustrations of a queue during processing of a priority data element in accordance with an embodiment of the present invention.

### DETAILED DESCRIPTION OF THE PRESENT EMBODIMENTS

Briefly, the present invention provides a technique for processing priority data elements between a host processor and a co-processor that exchange such data elements using a queue. In particular, the host processor first determines a priority of a data element received from an application, also implemented by the host processor. If the priority of the data element is higher than a lowest possible priority value, at least one lower priority data element within the queue may be identified and thereafter modified such that the at least one lower priority queued data element is temporarily removed from the queue. In accordance with an embodiment of the present invention, each queued data element comprises a priority indicator as well as a pointer to an immediately preceding queued data element and a pointer to an immediately subsequent queued data element. In a presently preferred embodiment, data elements that are written to the queue (including the pointers and priority indicator) are additionally written to a shadow buffer accessible by the host processor. When the priority data element is written into the queue, it is modified to include a query packet. When executed by the co-processor, the query packet causes the co-processor to provide the host processor with information regarding a last executed queued data element. Based on the information regarding the last executed queued data element, the host processor can determine one or more unmodified data elements (preferably determined using the shadow buffer) uniquely corresponding to the one or more modified queued data elements. Thereafter, the unmodified data elements are written into the queue in accordance with a sequence of the previously modified queued data elements. Because the present invention ensures that only data elements having a lower priority than the priority data element will be temporarily removed from the queue, higher priority data elements already in the queue will not be disturbed. In this manner, the present invention facilitates the use of multiple priority levels in systems comprising a host processor communicating with a co-processor via a queue.

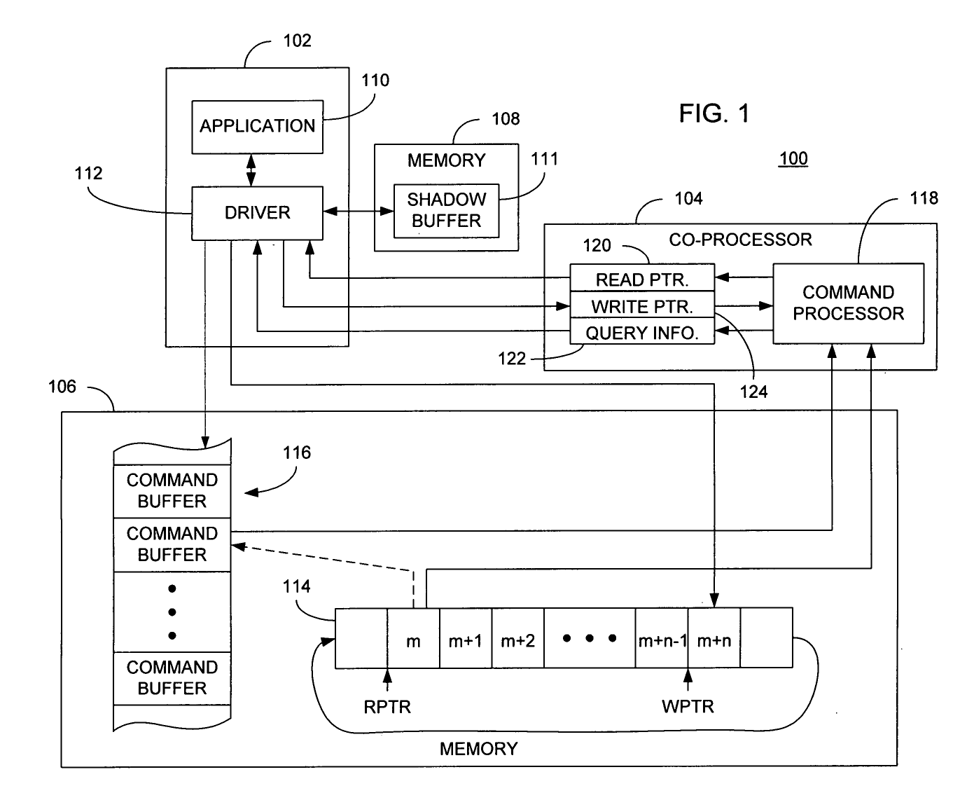

Referring now to the Figures, FIG. 1 is a schematic block diagram of a system in accordance with an embodiment of the present invention. In particular, the system 100 comprises a host processor 102, a co-processor 104 and memory 106. The system 100 may constitute a portion of any device that may benefit from a processor/co-processor arrangement such as, but not limited to, computers, printers, portable wireless communication devices, personal digital assistants, etc. The host processor 102, as known in the art, may comprise any device capable of executing stored instructions and operating upon stored data such as a microcontroller, a microprocessor, a digital signal processor, or combinations thereof. In a similar vein, the co-processor 104 may comprise any one or a combination of such processors, or one or more suitably configured programmable logic arrays such as an application specific integrated circuit (ASIC). As shown, the memory 106 may be accessed by either the host processor 102 or the co-processor 104 or both and may comprise any storage medium suitable for the storage of data and/or executable instructions such as volatile or non-volatile memory. An additional memory device 108, which preferably comprises cacheable volatile or non-volatile memory, is configured to be accessed by the host processor 102. Those having ordinary skill in the art will appreciate that other configurations of a host processor 102, co-processor 104 and memory 106 may be equally employed.

In operation, the host processor 102 implements one or more applications 110 (only one shown). As further known in the art, each application 110 having a need to communicate data elements for further processing by the co-processor 104 may communicate with a driver element 112. Both the application 110 and driver 112 are preferably implemented as stored software routines that are subsequently executed by the host processor 102 using known programming techniques. In operation, the driver 112 provides the application 110 access to one or more command buffers 116 stored in memory 106. Typically, when the application 110 desires to have the co-processor 104 carry out certain processing, it first populates a command buffer 116, through the driver 112, with data elements that may be properly processed by the co-processor 104. The application 110 requests the driver 112 to have the co-processor 104 process the data elements preciously written into the command buffer. In turn, the driver 112 writes certain elements into the queue 114, which data elements, when processed by the co-processor 104, cause the co-processor 104 to access the relevant command buffer for further processing by the co-processor 104. For this reason, each command buffer 116 is often referred to as an indirect buffer (IB). In order to know where to write into the queue 114, the driver 112 maintains a write pointer (WPTR) which indicates the next available location within the queue 114 that the driver 112 may write into. For example, this is illustrated in FIG. 1 where the driver 112 is shown writing a data element labeled m+n into a location within the queue 114 pointed to by the write pointer.

In a manner akin to the host processor 102, the co-processor 104 maintains a read pointer (RPTR) that indicates where the co-processor 104 should next look within the queue 114 to fetch the next data element for processing. This is further illustrated in FIG. 1 where the co-processor 104 is shown reading a data element labeled m that is pointed to by the read pointer. The co-processor 104 comprises a command processor 118 which carries out the actual processing of data elements within the queue 114. Additionally, the co-processor 104 maintains a read pointer register 120 and a query information register 122 that may be read by the driver 112. Likewise, the host processor 102, maintains a write pointer register 124 that may be read by the co-processor 104. The registers 120-124 allow the processors 102, 104 to readily share status information.

As shown, the memory 108 in communication with the host processor 102 preferably implements a shadow buffer 111. In accordance with the present invention, the shadow buffer 111 is used to store those data elements that are written into the queue 114, i.e., queued data elements. Thereafter, as described below, the process of identifying and modifying lower priority data elements within the queue 114 in response to a high priority data elements is implemented using the shadowed data elements stored in the shadow buffer 111. In this manner, the driver 112 can avoid performing read operations upon the queue 114 which, given the shared access nature of the queue 114, would lead to inefficiencies and delays in processing the queue 114.

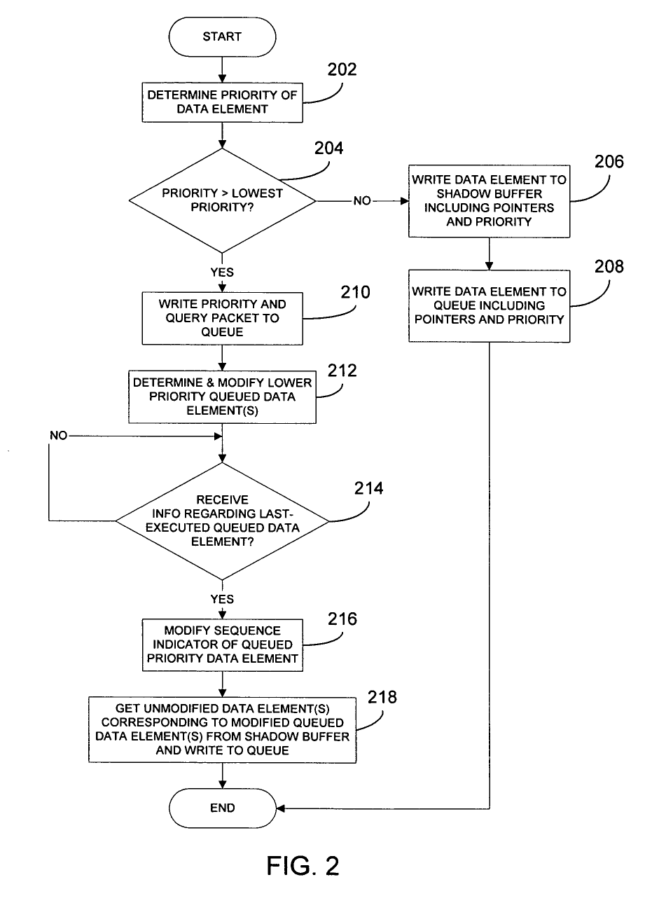

FIG. 2 is a flowchart illustrating processing by a host processor of a priority data element in accordance with an embodiment of the present invention. Generally, the processing illustrated in FIG. 2 may be implemented entirely in hardware using, for example, state machines operating under the control of appropriately programmed logic circuits. Preferably, the process is implemented using a general purpose or specialized processor (such as the host processor 102) operating under the control of executable instructions that are stored in volatile or non-volatile memory such as RAM or ROM or any other suitable storage element. Further still, as those of ordinary skill in the art will readily appreciate, the combination of hardware and software components may be equally employed.

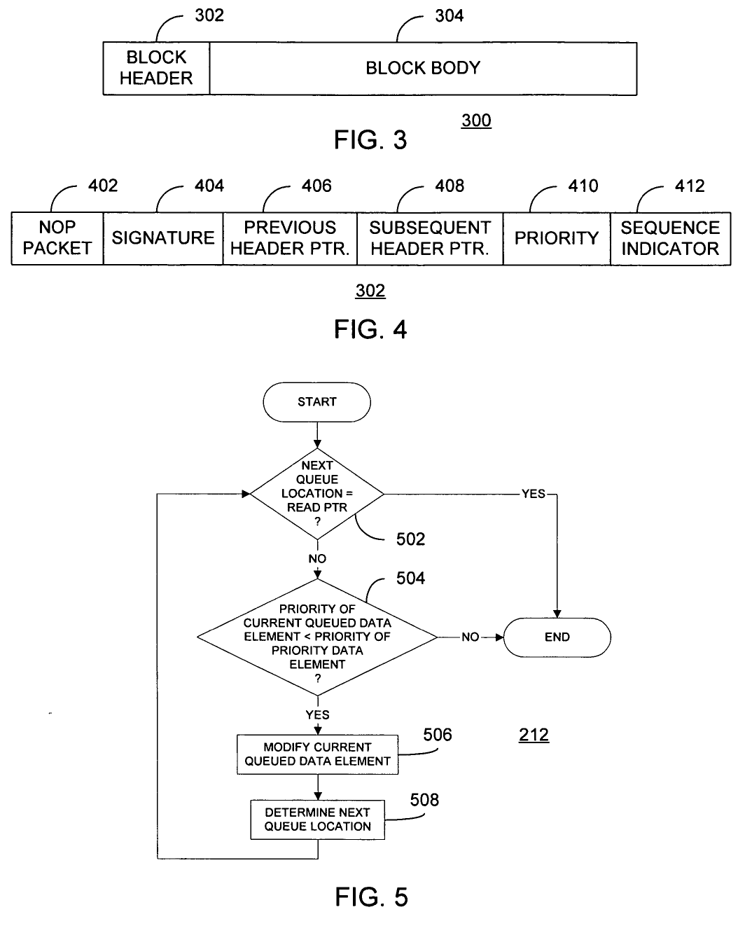

Regardless, at block 202 the host processor first determines a priority of a data element received from an application. In a presently preferred embodiment, this is accomplished by inspecting the types of commands being submitted by the application and determining an appropriate priority level. For example, the present invention may incorporate the use of a three-tiered priority scheme: namely, high, medium and low level priorities. In the example of a video graphics co-processor, data elements concerning the drawing of elemental graphics or pixel shading may be determined to be low priority data elements. In contrast, those data elements concerning computationally intensive or real-time sensitive video processing techniques such as scaling of video content or interlacing may be designated as medium or even high priority levels. Other schemes for determining priority of data elements may be devised by those having skill in the art that may be equally employed by the present invention. Regardless, at block 204, it is determined whether the priority for the data element under consideration is higher than the lowest possible priority. If the priority of the data element is not higher than the lowest priority (i.e., it is of the lowest priority) then processing continues at block 206 where the host processor writes the data element to the shadow buffer. In accordance with one embodiment of the present invention, when the data element is written into the shadow buffer, additional information concerning the priority of the data element as well as information concerning the location of adjacent data elements is also written into the shadow buffer. This is further illustrated in FIGS. 3 and 4.

As shown in FIG. 3, data elements 300 in accordance with the present invention comprise a block header 302 and a block body 304. The block header 302 comprises information about the data element, whereas the block body 304 comprises that portion of the data element that provides instructions to the co-processor, or that may provide an indication where the co-processor may look for further data elements for processing. FIG. 4 illustrates the block header 302 in greater detail. In particular, the block header 302 preferably comprises a no-operation packet (NOP) 402, a signature 404, a pointer to an immediately preceding queued data element 406, a pointer to an immediately subsequent queued data element 408, a priority indicator 410 and a sequence indicator 412. The NOP packet 402 provides a means for skipping over at least a portion of the data element 300. In particular, when the NOP packet 402 it is interpreted by the co-processor, the co-processor is instructed to skip a number of locations (e.g., words, bytes, etc.) within the queue defined within the NOP packet 402. In normal operation, the skip length indicated by the NOP packet 402 is equal to the length of the block header 302 such that the co-processor will essentially ignore the block header 302 and proceed immediately to the block body 304. However, as described in further detail below, in one embodiment of the present invention, the NOP packet 402 of a given data element may be modified to include a skip length that will cause the co-processor to skip not only the block header 302 but also the block body 304. In this manner, the data element so modified will be effectively removed from the queue to the extent that the co-processor will skip past it. The signature 404, as known in the art, is for error checking purposes and is used to ensure the integrity of the block header 302 and block body 304.

In a preferred embodiment of the present invention, the header 202 of each queued data element is also modified to include a pointer to an immediately preceding queued data element 406 as well as a pointer to an immediately subsequent queued element 408. In practice, each pointer actually points to the location corresponding to the beginning of the header for the corresponding preceding or subsequent queued data element. Such pointers allow for data elements of various lengths. However, if all data elements have the same length, such pointers are not necessary. When stored in a processor-readable medium (such as the queue 114 of the memory 106 or, preferably, the shadow buffer 111 of the additional memory 108), the header 302 constitutes a data structure useful for implementing various aspects of the present invention. For example, and as described in further detail below, the pointers 406, 408 provide the ability to quickly traverse through queued data elements (preferably using the shadow buffer).

The priority indicator 410 reflects the priority determined by the driver for the given data element at block 202. The particular value of the priority indicator 410 may comprise any of the number of predetermined priority levels. For example, in a presently preferred embodiment, at least three priority levels are determined in advance. In this instance, the priority levels may be labeled as high, medium and low. Of course, it is understood that a greater or lesser number of priority levels may be determined as a matter of design choice without loss of generality of the present invention.

Finally, the sequence indicator 412 is provided which enables the co-processor to ensure that the queued data elements are processed in order. As described in further detail below, when lower priority data elements are effectively removed from the queue, a sequence indicator for the priority data element that lead to the preemption of the lower priority data element(s) needs to be modified in order to ensure proper processing by the co-processor and/or host processor.

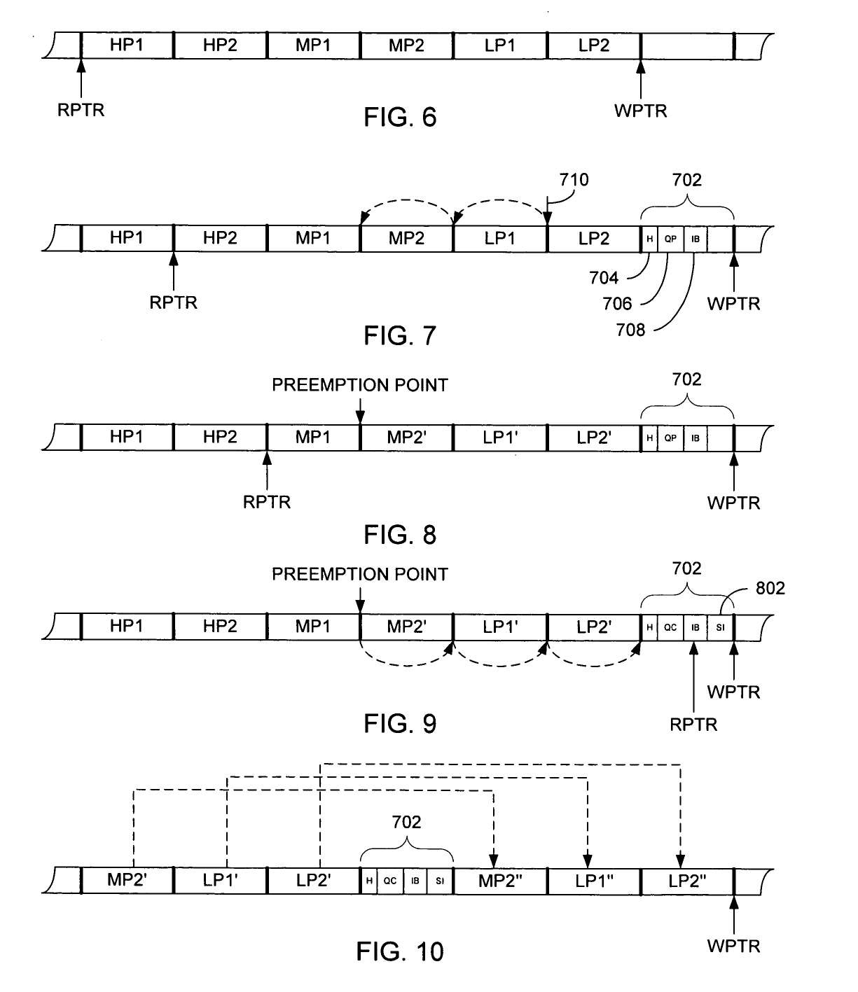

Referring once again to FIG. 2, the data elements that were written into the shadow buffer at block 206 are likewise written by the driver into the queue at block 208. Note that the headers of the queued data elements may be identical to the headers for the shadowed data elements (i.e., those data elements written into the shadow buffer at block 206, including the pointers and priority indications). However, it is also possible to leave the signature 404, pointers 406, 408, priority indicator 410 and/or sequence indicator 412 out of the headers of the queued data elements. If, however, at block 204 the priority of the data element under consideration is higher than the lowest priority (i.e., it is not the lowest priority) then processing continues at block 210 where the priority data element is written to the queue. As part of the priority data element, the header thereof is modified to include a query packet. The query packet, when processed by the co-processor, causes the co-processor to provide the host processor with information regarding a last executed queued data element. In this manner, the host processor (driver) can determine when the lower priority data element(s) has been skipped. Additionally, this information also allows the host processor to determine how the sequence indicator of the priority data element should be updated in order to preserve proper sequencing. This process is further illustrated with reference to FIG. 6 and 7.

FIG. 6 illustrates an exemplary queue in accordance with the present invention. As shown in FIG. 6, six data elements have been written into the queue and are awaiting processing by the co-processor. A read pointer is shown pointing to the next data element to be read (in this case, the data element labeled HP1). Furthermore, the write pointer is illustrated pointing to the next available location in the queue for the host processor to write a data element. The exemplary data elements illustrated in FIG. 6 each comprise one of three different priority levels. Thus, proceeding from the left of the figure, there are two high priority data elements, labeled HP1 and HP2, two middle priority data elements labeled MP1 and MP2, and two low-priority data elements labeled LP1 and LP2. Referring now to FIG. 7, the queue is illustrated shortly after a priority data element 702 has been written into the queue. Note that the write pointer now points to a location within the queue immediately after the priority data element 702. The priority data element 702 comprises a header 704, a query packet 706, and a pointer to an indirect or command buffer 708 as described above. At this point in time, the priority data element 702 does not include a sequence indicator.

Referring once again to FIG. 2, processing continues at block 212 where one or more lower priority queued data elements are possibly determined (identified) and modified to thereby give preference to the priority data element 702 written into the queue at block 210. A presently preferred technique for performing the processing at block 212 is further illustrated with reference to FIG. 5. At block 502, and beginning from the point within the queue immediately preceding the priority data element 702, the driver first determines whether a next queue location is equivalent to the location currently pointed to by the read pointer. For example, with reference to FIG. 7, the next location within the queue is indicated by a pointer 710 (in this case, pointing to the low priority data element labeled LP2). At this point in time, the read pointer, illustrated as pointing to the data element labeled HP2, is not equivalent to the pointer 710 to the next location within the queue. If, at block 502, the next queue location is equal to the read pointer, this is an indication that the co-processor has already processed all those data elements in the queue immediately preceding the priority data element 702. Therefore, there is no need to attempt to preempt any previous data elements within the queue. It should be noted that, although the processing illustrated in FIG. 5 assumes that the process of identifying lower priority data elements begins with the queued data element immediately prior to the priority data element 702 and proceeds backward in the queue from there, in practice, the process could begin with any queued data element between the priority data element 702 and the read pointer and could proceed either forward or backward in the queue, although this is not preferred.

Regardless, assuming, that the next queue location is not equivalent to the location currently pointed to by the read pointer, processing continues at block 504 where it is determined whether the priority of the priority data element 702 is greater than the priority of a current queued data element (i.e., in the example of FIG. 7, the queued data element labeled LP2). If the priority of the priority data element is not greater than the priority of the current queued data element, this is an indication that the current queued data element has a priority that is at least equivalent to if not greater than the priority data element. As such, it is not necessary to preempt the current queued data element in favor of the priority data element 702 because the current queued data element must be processed first. If, however, the condition at block 504 is satisfied, processing continues at block 506 where the current queued data element is modified such that the resulting modified queued data element is effectively temporarily removed from the queue. In the presently preferred embodiment, this modification is accomplished by modifying the header of the current queued data element to adjust the skip length of the NOP packet 402 to be equivalent to the length of the entire current queued data element, rather than just the header. In this manner, when the co-processor reaches the current queued data element, it will execute the NOP packet 402 and, by virtue of the modified skip length, will skip the entirety of the current queued data element including its block body. Those having ordinary skill in the art will appreciate that other techniques may be used to cause the co-processor to skip the modified queued data element. For example, the skip length could be set to skip directly to the query packet.

Regardless, processing thereafter continues at block 508 where the next location within the queue is determined. In the presently preferred embodiment, this is accomplished by inspecting the header of the current queued data element (e.g., LP2) to ascertain the location pointed to by its pointer to an immediately preceding queued data element, i.e., LP1. Processing thereafter continues at block 502 based on this newly-determined next queue location. In short, the process illustrated in FIG. 5 continually works backward from the priority data element 702 until either the read pointer is encountered or the current queued data element has a priority that is greater than or is equal to that of the priority data element 702. After this process has completed (assuming the conditions described in blocks 502 and 504 have been met), the queue will include one or more modified queued data elements as further illustrated in FIG. 8. As shown in FIG. 8, the queue now includes a plurality of modified queued data elements (labeled in this example as MP2′, LP1′ and LP2′). Additionally, a preemption point is illustrated in FIG. 8. The preemption point illustrates the start of those data elements that were modified to be skipped by the co-processor. Viewed another way, the preemption point is indicative of the last executed queued data element within the queue, i.e., that data element labeled MP1.

Referring once again to FIG. 2, processing continues at block 214 where it is determined whether the host processor has received information regarding the last executed queued data element. This is further illustrated in FIG. 9 where the modified queued data elements (MP2′, LP1′ and LP2′) are skipped by the co-processor as illustrated by the dashed arrows. Once again, the processor skips these modified data elements because they had been modified to include a skip length equivalent to the entire length of the data element being skipped. Thereafter, as the co-processor begins to process the priority data element 702, it will first process the header 704 and then encounter the query packet 706, described above. When the co-processor processes the query packet 706, it causes the processor to return information regarding the last executed queued data element within the queue, preferably via the query information register described above as a pointer or other indicia to that data element within the queue immediately preceding the preemption point (i.e., that data element labeled MP1 in FIG. 9). When the information regarding the last executed queued data element is received by the host processor of block 214, the sequence indicator for that last executed data element may be ascertained by inspecting the sequence indicator found within the header of a corresponding data element in the shadow buffer. Based on this sequence indicator, the driver may determine an updated sequence indicator for the priority packet 702, which sequence indicator 702 is thereafter written into the priority data element 702 as illustrated in FIG. 9. The sequence indicator 802 is selected to ensure that the sequence relative to the last executed queued data element is continuous. For example, where the sequence indicator is a sequentially increasing integer for each queued data element, the updated sequence indicator 802 is selected to ensure that it is greater than the sequence indicator ascertained for the last executed queued data element.

Additionally, at block 218, one or more unmodified data elements corresponding to the one or more modified queued data elements (assuming there are any) are determined, preferably during the inspection of the shadow buffer based on the information regarding the last executed queued data element. Referring once again to FIGS. 8 and 9, knowledge of the preemption point allows the driver to determine the corresponding location within the shadow buffer and thereby determine the identity of corresponding unmodified data element within the shadow buffer. Upon determining these unmodified data elements, the driver writes the unmodified data elements to the queue in accordance with its normal operation (i.e., to those locations pointed to by the write pointer). This is further illustrated in FIG. 10 where unmodified data elements MP2″, LP1″ and LP2″ are written into those locations within the queue immediately subsequent to the priority data element 702. Note that each unmodified data element comprises a header in which the NOP packet includes the “normal” skip length, i.e., the co-processor will only skip the header for the unmodified data element.

The present invention provides a technique for providing priority processing in systems comprising a processor in communication with a co-processor via a shared queue. By comparing the priority of a given data element to be written into the queue with the priorities of one or more queued data elements, queued data elements may by identified for pre-emption by the priority data element. Such pre-emption is accomplished by modifying the queued data elements thus identified. Thereafter, the pre-empted queued data elements can be restored in the queue in an unmodified form. In this manner, the present invention allows for priority processing by the co-processor without suffering the shortcomings of other techniques.

It is therefore contemplated that the present invention cover any and all modifications, variations or equivalents that fall within the spirit and scope of the basic underlying principles disclosed above and claimed herein.

What is claimed is:

1. In a system comprising a host processor interacting with a co-processor via at least a queue, a method in the host processor for processing a priority data element to be written into the queue by the host processor, the method comprising:
determining a priority of the priority data element;
when the priority of the priority data element is higher than a lowest possible priority value, comparing the priority of the priority data element with a priority of at least one queued data element to determine at least one lower priority queued data element, wherein each of the at least one lower priority queued data element has a priority lower than the priority for the priority data element; and
modifying one or more of the at least one lower priority queued data element to provide at least one modified queued data element such that the at least one modified queued data element is temporarily removed from the queue.

2. The method of claim 1, further comprising:
writing at least one data element into the queue to provide the at least one queued data element, wherein each of the at least one queued data element comprises a pointer to an immediately preceding queued data element, a pointer to an immediately subsequent queued data element and a priority indicator.

3. The method of claim 2, wherein comparing the priority of the priority data element further comprises:
accessing the priority indicator of a current queued data element of the at least one queued data element to determine the priority of the current queued data element;
determining that the current queued data element is a lower priority queued data element based on the priority indicator of current queued data element;
when the current queued data element is a lower priority queued data element, modifying the current queued data element such that the co-processor will skip processing of the current queued data element; and
when the current queued data element is a lower priority queued data element, determining a location within the queue of a next queued data element of the at least one queued data element based on either the pointer to the immediately preceding queued data element of the current queued data element or the pointer to the immediately subsequent queued data element of the current queued data element.

4. The method of claim 3, further comprising:
writing each of the at least one queued data element into a shadow buffer accessible by the host processor to provide at least one shadowed data element, wherein accessing the current priority indicator of the current queued data element and determining a location within the queue of the next queued data element are performed based on uniquely corresponding shadowed data elements of the at least one shadowed data element.

5. The method of claim 1, further comprising:
writing the priority data element and a query data element into the queue subsequent to the at least one modified queued data element to provide a queued priority data element and a queued query data element, wherein the queued query data element, when processed by the co-processor, cause the co-processor to provide the host processor with information regarding a last-executed queued data element in the queue.

6. The method of claim 5, further comprising:
determining, for each modified queued data element of the at least one modified queued data element based on the information regarding the last-executed queued data element, an unmodified data element uniquely corresponding to the modified queued data element to provide at least one unmodified data element; and
writing the at least one unmodified data element into the queue in accordance with a sequence of the at least one modified queued data element.

7. The method of claim 6, further comprising:
modifying a sequence indicator of the queued priority data element based on the information regarding the last-executed queued data element.

8. A processor-readable medium having stored thereon processor-executable instructions that, when executed by a processor that interacts with a co-processor via at least a queue, cause the processor to:
determine a priority of a priority data element to be written into the queue;
when the priority of the priority data element is higher than a lowest possible priority value, compare the priority of the priority data element with a priority of at least one queued data element to determine at least one lower priority queued data element, wherein each of the at least one lower priority queued data element has a priority lower than the priority for the priority data element; and
modify one or more of the at least one lower priority queued data element to provide at least one modified queued data element such that the at least one modified queued data element is temporarily removed from the queue.

9. The processor-readable medium of claim 8, further comprising processor-executable instructions that, when executed by the processor, cause the processor to:
write at least one data element into the queue to provide the at least one queued data element, wherein each of the at least one queued data element comprises a pointer to an immediately preceding queued data element, a pointer to an immediately subsequent queued data element and a priority indicator.

10. The processor-readable medium of claim 9, further comprising processor-executable instructions that, when executed by the processor, cause the processor to:
access the priority indicator of a current queued data element of the at least one queued data element to determine the priority of the current queued data element;
determine that the current queued data element is a lower priority queued data element based on the priority indicator of current queued data element;
when the current queued data element is a lower priority queued data element, modify the current queued data element such that the co-processor will skip processing of the current queued data element; and
when the current queued data element is a lower priority queued data element, determine a location within the queue of a next queued data element of the at least one queued data element based on either the pointer to the immediately preceding queued data element of the current queued data element or the pointer to the immediately subsequent queued data element of the current queued data element.

11. The processor-readable medium of claim 10, further comprising processor-executable instructions that, when executed by the processor, cause the processor to:
write each of the at least one queued data element into a shadow buffer accessible by the host processor to provide at least one shadowed data element, wherein accessing the current priority indicator of the current queued data element and determining a location within the queue of the next queued data element are performed based on uniquely corresponding shadowed data elements of the at least one shadowed data element.

12. The processor-readable medium of claim 8, further comprising processor-executable instructions that, when executed by the processor, cause the processor to:
write the priority data element and a query data element into the queue subsequent to the at least one modified queued data element to provide a queued priority data element and a queued query data element, wherein the queued query data element, when processed by the co-processor, cause the co-processor to provide the host processor with information regarding a last-executed queued data element in the queue.

13. The processor-readable medium of claim 12, further comprising processor-executable instructions that, when executed by the processor, cause the processor to:
determine, for each modified queued data element of the at least one modified queued data element based on the information regarding the last-executed queued data element, an unmodified data element uniquely corresponding to the modified queued data element to provide at least one unmodified data element; and
write the at least one unmodified data element into the queue in accordance with a sequence of the at least one modified queued data element.

14. The processor-readable medium of claim 13, further comprising processor-executable instructions that, when executed by the processor, cause the processor to:
modify a sequence indicator of the queued priority data element based on the information regarding the last-executed queued data element.

15. A system comprising:
a storage device comprising a queue;
a co-processor coupled to the storage device; and
a host-processor coupled to the storage device and operative to:
determine a priority of a priority data element to be written into the queue;
when the priority of the priority data element is higher than a lowest possible priority value, compare the priority of the priority data element with a priority of at least one queued data element to determine at least one lower priority queued data element, wherein each of the at least one lower priority queued data element has a priority lower than the priority for the priority data element; and
modify one or more of the at least one lower priority queued data element to provide at least one modified queued data element such that the at least one modified queued data element is temporarily removed from the queue.

16. The system of claim 15, wherein the host processor is further operative to:
write at least one data element into the queue to provide the at least one queued data element, wherein each of the at least one queued data element comprises a pointer to an immediately preceding queued data element, a pointer to an immediately subsequent queued data element and a priority indicator.

17. The system of claim 16, wherein the host processor is further operative to:
access the priority indicator of a current queued data element of the at least one queued data element to determine the priority of the current queued data element;
determine that the current queued data element is a lower priority queued data element based on the priority indicator of current queued data element;
when the current queued data element is a lower priority queued data element, modify the current queued data element such that the co-processor will skip processing of the current queued data element; and
when the current queued data element is a lower priority queued data element, determine a location within the queue of a next queued data element of the at least one queued data element based on either the pointer to the immediately preceding queued data element of the current queued data element or the pointer to the immediately subsequent queued data element of the current queued data element.

18. The system of claim 17, further comprising:
another storage device coupled to the host processor and comprising a shadow buffer, wherein the host processor is further operative to write each of the at least one queued data element into a shadow buffer accessible by the host processor to provide at least one shadowed data element, wherein accessing the current priority indicator of the current queued data element and determining a location within the queue of the next queued data element are performed based on uniquely corresponding shadowed data elements of the at least one shadowed data element.

19. The system of claim 15, wherein the host processor is further operative to:
write the priority data element and a query data element into the queue subsequent to the at least one modified queued data element to provide a queued priority data element and a queued query data element, wherein the queued query data element, when processed by the co-processor, cause the co-processor to provide the host processor with information regarding a last-executed queued data element in the queue.

20. The system of claim 19, wherein the host processor is further operative to:
determine, for each modified queued data element of the at least one modified queued data element based on the information regarding the last-executed queued data element, an unmodified data element uniquely corresponding to the modified queued data element to provide at least one unmodified data element; and
write the at least one unmodified data element into the queue in accordance with a sequence of the at least one modified queued data element.

21. The system of claim 20, wherein the host processor is further operative to:
modify a sequence indicator of the queued priority data element based on the information regarding the last-executed queued data element.

22. A processor-readable medium having stored thereon a data element structure, comprising:
a first data field comprising commands to processed by a co-processor; and
a priority field comprising a priority indication, wherein during processing of the commands, the priority indication is examined to determine whether the commands should be processed by the co-processor with a higher priority than other commands to be processed by the co-processor.

23. The processor-readable medium of claim 22, the data element structure further comprising:
a first pointer field comprising a pointer to an immediately preceding data element structure.

24. The processor-readable medium of claim 22, the data element structure further comprising:
a second pointer field comprising a pointer to an immediately subsequent data element structure.
